(19) United States
(12) Patent Application Publication
(10) Pub. No.: US 2007/0221070 A1
(43) Pub. Date: Sep. 27, 2007

(54) Cooker and Cooking Method

(75) Inventors: Hideko Akashi, Nara (JP); Ikuhiro Inada, Nara (JP); Masato Matsuda, Nara (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 10/599,817

(22) PCT Filed: Apr. 14, 2005
(86) PCT No.: PCT/JP05/07241

§ 371 Date: Oct. 11, 2006

(30) Foreign Application Priority Data
Apr. 22, 2004 (JP) 2004-126434

(51) Int. Cl. A23L 1/025; A47J 27/04

(52) U.S. Cl. 99/331; 426/510

(57) ABSTRACT

The problem to be solved by the invention is that, when an object to be heated is heated using steam, the atmospheric temperature of the interior of the heating chamber is set quickly and accurately at a temperature suitable for cooking to thereby cook the object to be heated with uniform steam heating.

The above problem can be solved by providing a cooking apparatus for supplying steam to a heating chamber 11 storing an object to be heated to thereby heat the object to be heated, which comprises steam supply means for supplying steam to the heating chamber 11, a fan 17 for stirring up the steam supplied to the interior of the heating chamber 11, and temperature control means, by driving and rotating the fan 17, for controlling the atmospheric temperature of the interior of the heating chamber 11 to be lower than the temperature of the steam supplied.

### TECHNICAL FIELD

The present invention relates to a cooking apparatus and a cooking method for cooking a foodstuff by supplying steam to a heating chamber.

### BACKGROUND ART

In recent years, there has been widely popularized a cooking apparatus as a product of mass production which has not only the function of a microwave oven capable of high-frequency heating but also a steam generating function to thereby be able to enforce the high-frequency heating and steam heating simultaneously with each other or independently of each other. When a cooking apparatus of this type is used to cook a foodstuff using the steam heating, in order to achieve the cooking quickly and positively, ideally, it is important to keep the heating chamber of the cooking apparatus in a steam density of nearly 100% and at a temperature suitable for the foodstuff (for example, 80° C. for an egg, 98° C. for a Chinese meat-bun, and 100° C. or higher for a steamed sweet potato).

Especially, in the case of egg cooking, accurate temperature control is important for successful cooking and, therefore, a method for controlling the temperature of the interior of the heating chamber in the cooking is devised so that the temperature can be set at a desired temperature. For example, there is disclosed in the patent reference 1 a steam-heating type cooking apparatus which adjusts the steam partial pressure of the interior of the heating chamber (a volume ratio occupied by the steam) to thereby set the atmospheric temperature of the interior of the heating chamber.

Patent Reference 1: Japanese Patent Publication Sho-63-254320

### DISCLOSURE OF THE INVENTION

### PROBLEMS THAT THE INVENTION IS TO SOLVE

By the way, conventionally, there exists an electronic cooking range which is capable of using oven heating. However, as will be discussed below, when compared with the steam heating, the oven heating can raise an inconvenience in cooking.

As shown in FIG. 13, when cooking “chawan-mushi” (a Japanese steamed-egg hotchpotch) using the oven heating which circulates hot wind within a heating chamber 201, it takes longer time to cook than when cooking the “chawan-mushi” using the steam heating, and the finished state of the chawan mushi is not satisfactory. In other words, in a state where the heating temperature is set at 150° C., when the “chawan-mushi” is cooked while the finishing temperature thereof is set at the temperature of 96° C.-98° C. (F₁), it takes time about double when compared with the cooking using the steam heating (F₀) (see FIG. 7); and, with regard to the finished state of the cooking, in the case of F₁, as shown in FIG. 14, the peripheral portions 205a of a vessel 206 are over-cooked so that bubbles-state is caused. On the other hand, when the “chawan-mushi” is cooked while the finishing temperature is set low in the range of about 70° C.-75° C. (F₂), as shown in FIG. 15, the central portion 205b of the vessel 206 is an uncooked state, namely, lack of heating. In this manner, in the case of the oven heating, since heating is carried out while using the air as a heat transfer medium, there is a limit to an increase in the amount of heat transfer to an object to be heated 202; and, therefore, there occurs a great difference in temperature between the surface and interior of the object to be heated 202 and thus, in most cases, it is difficult to heat the object to be heated 202 quickly and uniformly.

Thus, especially, in egg cooking or similar cooking which requires severe heating temperature control, depending on the presence or absence of a steam heating function, there is produced a great difference in the finished state and cooking time. And, the steam heating function is requested to be able to lower the atmospheric temperature of the interior of the heating chamber by a given temperature down from the temperature of 100° C. where the steam is generated.

Also, in the above-mentioned cooking apparatus disclosed in the cited patent reference 1, the atmospheric temperature of the interior of the heating chamber is set at a temperature of 90° C. or so which is lower than 100° C. by mixing the open air with the steam of 100° C. However, since the open air is introduced from a hole (an open air communication portion) formed in a portion of the heating chamber and the air is diffused into the steam only through the rising operation of the steam supplied, the diffusion effect of the air is actually small, with the result that a sufficient air diffusion state cannot be obtained. Therefore, according to the above-cited cooking apparatus, the interior of the heating chamber cannot be set at a desired atmospheric temperature quickly and accurately, it is still difficult to achieve the above-mentioned cooking stably.

The invention is made in view of the above-mentioned circumstances of the conventional cooking apparatus. Thus, it is an object of the invention to provide a cooking apparatus and a cooking method which, when heating an object to be heated using steam, can set the atmospheric temperature of a heating chamber at a temperature suitable for cooking quickly and accurately to thereby be able to cook the object to be heated with uniform steam heating.

### MEANS FOR SOLVING THE PROBLEMS

The above object can be attained by providing a cooking apparatus and a cooking method which are set forth in the following articles.

(1) A cooking apparatus for supplying steam to a heating chamber storing an object to be heated therein to heat the object, includes: steam supply means for supplying steam to the heating chamber; a fan for stirring up steam supplied to the interior of the heating chamber; and, temperature control means, by driving and rotating the fan, for controlling the atmospheric temperature of the interior of the heating chamber to be lower than the temperature of the steam supplied.

According to the present cooking apparatus, the steam supplied to the interior of the heating chamber by the steam supply means is stirred up by the rotational movement of the fan driven by the temperature control means, whereby the atmospheric temperature of the interior of the heating chamber can be controlled at a temperature lower than the temperature of the steam supplied. That is, the heating chamber can be set at an arbitrary temperature suitable for cooking, so that cooking using heating such as egg cooking requiring the accurate setting of the temperature can be executed quickly and positively.

(2) A cooking apparatus as set forth in the article (1), further including heating means for raising the atmospheric temperature of the interior of the heating chamber.

According to the present cooking apparatus, since it includes the heating means for raising the atmospheric temperature of the interior of the heating chamber, dew condensation due to the steam generated can be reduced and the atmospheric temperature of the interior of the heating chamber can be kept at a desired temperature or higher.

(3) A cooking apparatus as set forth in the article (1) or (2), wherein the heating chamber is separated from a circulation fan chamber with the fan disposed therein through a partition plate and, in the partition plate, there is formed a ventilation hole for allowing the heating chamber and circulation fan chamber to communicate with each other.

According to the present cooking apparatus, steam rising from an evaporation dish is sucked by the circulation fan through an air intake ventilation hole formed in the partition plate, is moved through the circulation fan chamber, and is blown out from an air exhaust ventilation hole formed in the partition plate toward the interior of the heating chamber. The thus blown-out steam is stirred up in the interior of the heating chamber, and is again sucked from the air intake ventilation hole of the partition plate to the circulation fan chamber, thereby forming a circulation passage in the interior of the heating chamber and in the circulation fan chamber.

(4) A cooking apparatus as set forth in any one of the articles (1) to (3), wherein open air supply means for supplying the open air is connected to the heating chamber.

According to the present cooking apparatus, because the open air supply means is connected to the heating chamber, the open air can be positively supplied to the interior of the heating chamber, which makes it possible to lower the atmospheric temperature of the interior of the heating chamber further quickly.

(5) A cooking apparatus as set forth in any one of the articles (1) to (3), wherein the open air supply means includes ventilating means for sucking the open air to generate a wind, an air intake ventilation passage for guiding the wind from the ventilating means to the interior of the heating chamber, and an air exhaust ventilation passage for exhausting the air existing in the interior of the heating chamber therefrom.

According to the present cooking apparatus, while supplying the steam to the interior of the heating chamber, not only the wind from the ventilating means is introduced through the air intake ventilation passage to the interior of the heating chamber but also the air existing in the interior of the heating chamber is exhausted therefrom through the air exhaust ventilation passage, whereby the steam supplied to the interior of the heating chamber is stirred up together with the open air to thereby be able to turn the interior of the heating chamber into a state of a desired steam density.

(6) A cooking apparatus as set forth in the article (5), wherein, in a portion of the air intake ventilation passage existing upstream of its connecting position with the heating chamber, there is disposed an air intake side shutter for limiting the amount of the air passing through the air intake ventilation passage.

According to the present cooking apparatus, owing to provision of the air intake side shutter on the air passage upstream side of the air intake ventilation passage, the flow rate of the air passing through the air intake ventilation passage can be varied freely and thus the amount of supply of the open air to the interior of the heating chamber can be varied.

(7) A cooking apparatus as set forth in the article (5) or (6), wherein, in a portion of the air exhaust ventilation passage existing downstream of its connecting position with the heating chamber, there is disposed an air exhaust side shutter for limiting the flow rate of the air passing through the air exhaust ventilation passage.

According to the present cooking apparatus, owing to provision of the air exhaust side shutter on the air passage downstream side of the air exhaust ventilation passage, the flow rate of the air passing through the air exhaust ventilation passage can be varied freely and thus the exhaust amount of the air from the interior of the heating chamber can be varied.

(8) A cooking apparatus as set forth in any one of the articles (1) to (7), further including a vertically dividing partition plate for dividing a space within the heating chamber into upper and lower section spaces, wherein, between the heating chamber and the vertically dividing partition plate, there is formed a communication portion for connecting together the upper and lower section spaces, and the steam supply means supplies steam from the lower section space of the heating chamber.

According to the present cooking apparatus, since the heating chamber is divided by the vertically dividing partition plate and the steam is supplied to the lower section space of the heating chamber, the steam supplied to the lower section space rises and collects in the upper section space through the communication portion. This rising and collecting action of the steam accelerates the stirring-up of the steam, thereby being able to make uniform the steam density of the upper section space of the heating chamber.

(9) A cooking method for supplying steam to a heating chamber storing an object to be heated therein to heat the object to be heated, in which, the object to be heated is heated while supplying steam to the interior of the heating chamber, and the steam supplied to the interior of the heating chamber is stirred up, whereby the atmospheric temperature of the interior of the heating chamber can be controlled to be lower than the temperature of the steam to be supplied.

According to the present cooking method, the steam supplied to the interior of the heating chamber by the steam supply means is stirred up by the rotational movement of the fan driven by the temperature control means, whereby the atmospheric temperature of the interior of the heating chamber can be controlled to be lower than the temperature of the steam to be supplied. That is, the heating chamber can be set at an arbitrary temperature suitable for cooking, so that cooking such as egg cooking requiring the accurate setting of the temperature can be executed quickly and positively.

(10) A cooking method as set forth in the article (9), wherein the stirring-up of the steam is executed by driving and rotating the fan and the atmospheric temperature of the interior of the heating chamber can be changed by controlling, specifically, increasing or decreasing the rotation speed of the fan.

According to the present cooking method, by increasing the rotation speed of the fan, an effect of lowering the atmospheric temperature of the interior of the heating chamber can be enhanced. Thus, by controlling the rotation speed of the fan, the atmospheric temperature of the interior of the heating chamber can be controlled.

(11) A cooking method as set forth in the article (9) or (10), wherein the stirring-up of the steam is executed by driving and rotating the fan and the atmospheric temperature of the interior of the heating chamber can be changed by controlling the rotation driving cycle of the fan.

According to the present cooking method, by shortening the rotation driving cycle of the fan, an effect of lowering the atmospheric temperature of the interior of the heating chamber can be enhanced. Thus, by controlling the rotation driving cycle of the fan, the atmospheric temperature of the interior of the heating chamber can be controlled.

### EFFECTS OF THE INVENTION

According to the present cooking apparatus and cooking method, by stirring up the steam supplied to the interior of the heating chamber, the atmospheric temperature of the interior of the heating chamber can be controlled to be lower than the temperature of the steam supplied, that is, the atmospheric temperature of the interior of the heating chamber can be lowered quickly and positively down to a temperature suitable for cooking an object to be cooked.

### BRIEF DESCRIPTION OF THE DRAWINGS

FIG. 1 is a front view of a cooking apparatus according to the invention, showing a state in which an opening and shutting door is opened.

FIG. 2 is an explanatory view of the basic operation of the cooking apparatus.

FIG. 3 is a block diagram of a control system employed in the cooking apparatus.

FIG. 4 is a graphical representation to show variations with time in the atmospheric temperature of the interior of a heating chamber with respect to the respective rotation speeds of a circulation fan.

FIG. 5 is a chart to show the cooking pattern of a chawan mushi (Japanese pot-steamed hotchpotch) to be cooked through a combination of steam supply and heating by a heater.

FIG. 6 is a chart to show an embodiment in which the atmospheric temperatures of the interior of a heating chamber are set so as to vary sequentially by switching the rotation speed of the circulation fan, more specifically, an embodiment in which the setting temperatures are lowered sequentially with the passage of time.

FIG. 7 is a chart to show an embodiment in which the atmospheric temperatures of the interior of a heating chamber are set so as to vary sequentially by switching the rotation speed of the circulation fan, more specifically, an embodiment in which the temperatures are set arbitrarily regardless of the passage of time.

FIG. 8 is a chart to show an embodiment in which the atmospheric temperatures of the interior of a heating chamber are set so as to vary sequentially by switching the rotation driving cycle of the circulation fan, more specifically, an embodiment in which the atmospheric temperatures of the interior of the heating chamber are set different from each other.

FIG. 9 is an explanatory view of the state of steam provided when a space within the heating chamber is vertically divided into upper and lower section spaces by a tray.

FIG. 10 is a perspective view of a modification of the tray.

FIG. 11 is a transverse section view of a cooking apparatus, showing a state where the tray shown in FIG. 10 is stored in the heating chamber.

FIG. 12 is a plan view of the schematic structure of an air intake and exhaust mechanism employed in the cooking apparatus.

FIG. 13 is an explanatory view of an example in which a chawan mushi is cooked using oven heating which circulates hot wind of high temperatures through a heating chamber according to a conventional cooking apparatus.

FIG. 14 is a plan view of a chawan mushi, showing a state in which the peripheral portions of a vessel are separated according to a conventional cooking apparatus or method.

FIG. 15 is a plan view of a chawan mushi, showing a state in which the central portion of the chawan mushi is not heated but is thereby not fixed properly according to the conventional cooking apparatus or method.

### DESCRIPTION OF REFERENCE NUMERALS AND SIGNS

10: Main body case
11A: Upper section space
11B: Lower section space
11a, 11b: Side wall surface
11: Heating chamber
14: Hot wind generating portion
15: Steam supply portion
16: Upper heating heater (Heating means)
17: Circulation fan
19: Convection heater (Heating means)
22: Tray
23: Drive motor
25: Circulation fan chamber
26: Securing portion
27: Deep side wall surface
29, 31: Ventilation hole
29: Air intake ventilation hole
31: Air feed ventilation hole
32: Magnetron cooling fan
32: Cooling fan
33: Stirrer blade
35a: Pool recessed portion
35: Evaporation dish
37: Evaporation dish heating heater
50: Shutter opening and shutting drive portion
51: Air intake side shutter
52: Air exhaust side shutter
53: Water tank
55: Waterpump
57: Water supply pipe line
60: Air supply fan
81: Air intake ventilation passage
82: Air intake port
85: Air exhaust ventilation passage
86: Air exhaust port
87: Discharge port
100: Cooking apparatus
200: Cooking apparatus
501: Control part
507: Input operation part
509: Display panel
G: Mixed gas
M: Object to be heated
S: Steam

### BEST MODE FOR CARRYING OUT THE INVENTION

Now, description will be given below in detail of preferred embodiments of a cooking apparatus according to the invention with reference to the accompanying drawings.

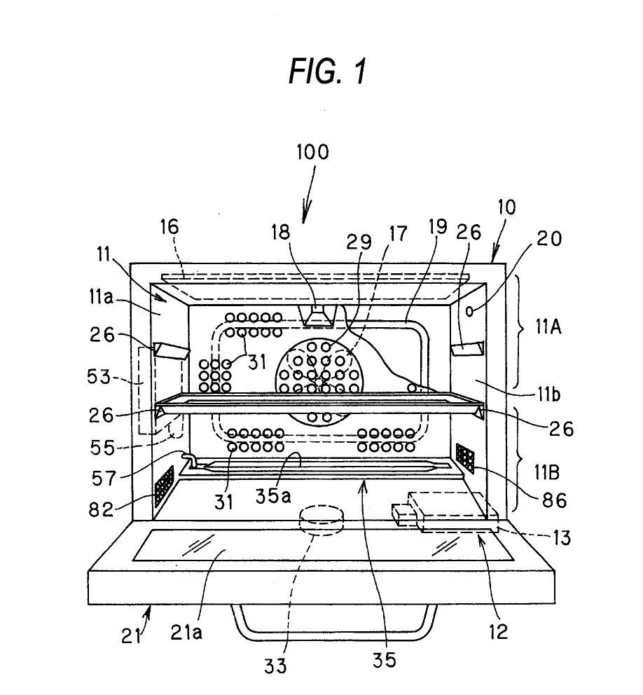

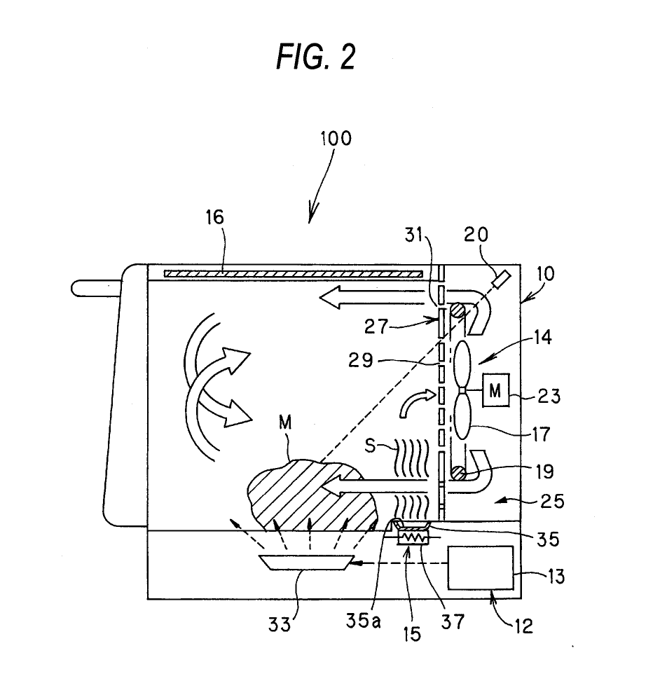

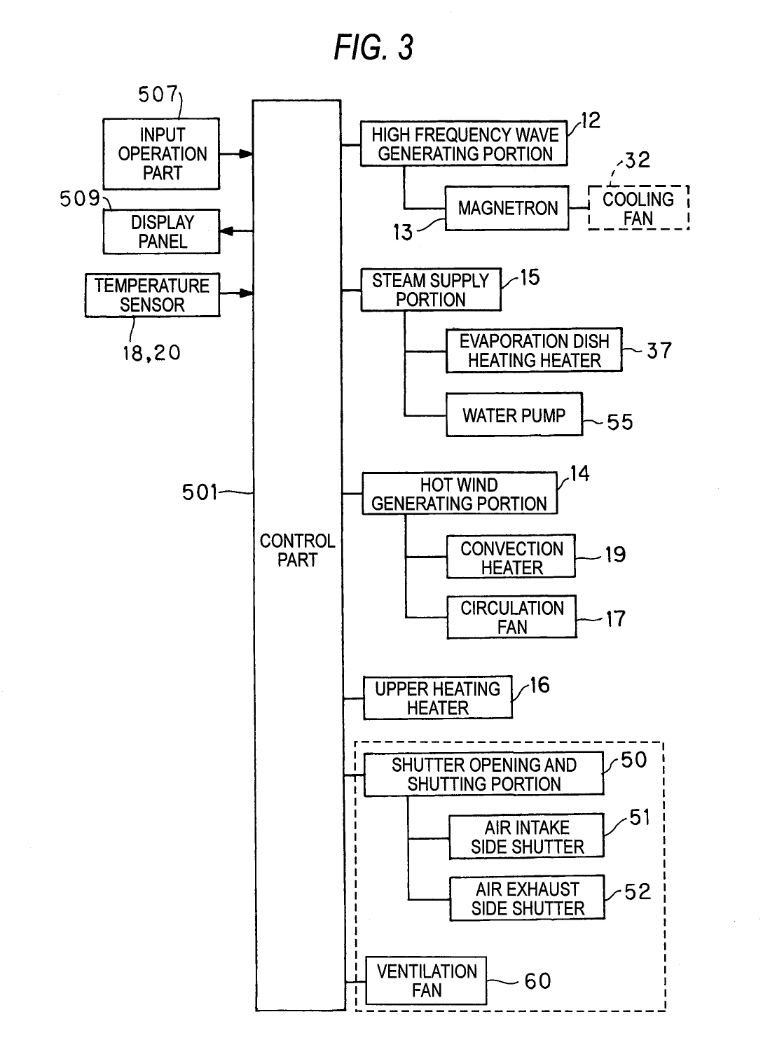

FIG. 1 is a front view of a cooking apparatus according to the invention, showing a state in which an opening and shutting door is opened, FIG. 2 is an explanatory view of the basic operation of the cooking apparatus, and FIG. 3 is a block diagram of a control system for controlling the cooking apparatus.

This cooking apparatus 100 is a cooking apparatus which supplies at least one of high frequency waves (microwaves) and steam S to a heating chamber 11 with an object to be heated stored therein to heat treat the object to be heated. The cooking apparatus 100 comprises a magnetron 13 serving as a high frequency wave generating portion 12 for generating high frequency waves, a steam supply portion 15 for generating steam S within the heating chamber 11, an upper heating heater 16 disposed upwardly of the heating chamber 11 and serving as heating means for heating the heating chamber 11, a circulation fan 17 for stirring up and circulating the air existing in the interior of the heating chamber 11, a convection heater 19 serving as other heating means for heating the air circulating within the heating chamber 11, an infrared sensor 18 for measuring the temperature of the interior of the heating chamber 11 through a detection hole formed in the wall surface of the heating chamber 11, a thermistor 20 disposed on the wall surface of the heating chamber 11 for measuring the temperature of an object to be heated M, and a tray 22 removably disposed upwardly of the bottom surface of the heating chamber 11 with a given clearance between them and serving as a vertically dividing partition plate for dividing the heating chamber 11 vertically into an upper section space and a lower section space.

As shown in FIGS. 1 and 2, the heating chamber 11 is formed in the interior of a box-shaped main body case 10 the front side of which is open and, on the front surface of the main body case 10, there is provided an opening and shutting door 21 with a transparent window 21 which is used to open and shut the object-to-be-heated take-out mouth of the heating chamber 11. The lower end of the opening and shutting door 21 is hinge connected to the lower edge of the main body case 10, whereby the opening and shutting door 21 can be opened and shut in the vertical direction. Between the wall surface of the heating chamber 11 and the wall surface of the main body case 10, there is secured a given adiabatic space; and, as the need arises, an adiabatic member is charged into the adiabatic space.

The magnetron 13 is disposed, for example, in the lower section space of the heating chamber 11 and, at a position for receiving high frequency waves generated from the magnetron 13, there is disposed a stirrer blade 33 (or a rotation antenna or the like) which serves as radio wave stirring means. The high frequency waves from the magnetron 33 are radiated onto the stirrer blade 33 which is rotating, whereby the high frequency waves are supplied to the interior of the heating chamber 11 while they are being stirred up by the stirrer blade 33. By the way, the mounting portions of the magnetron 13 and stirrer blade 33 are not limited to the bottom portion of the heating chamber 11 but they can also be disposed on the upper surface or side surfaces of the heating chamber 11.

As shown in FIG. 2, in a space behind the heating chamber 11, there is disposed a circulation fan chamber 25 in which the circulation fan 17 and its drive motor 23 are stored; and, the rear wall surface of the heating chamber 11 provides a deep side wall surface 27 which defines the heating chamber 11 and circulation fan chamber 25. In the deep side wall surface 27, there are formed air intake ventilation holes 29 for sucking the air from the heating chamber 11 side to the circulation fan chamber 25 side and air feed ventilation holes 31 for supplying the air from the circulation fan chamber 25 side to the heating chamber 11 side, while the respective formation areas of the air intake ventilation holes 29 and the air feed ventilation holes 31 are separated from each other. The respective ventilation holes 29 and 31 are formed in the form of a large number of punched holes.

A hot wind generating portion 14 is defined by the circulation fan 17 and convection heater 19. In other words, the circulation fan 17 is disposed substantially in the central position of the rectangular-shaped deep side wall surface 27. Within the circulation fan chamber 25, there is provided the rectangular-ring-shaped convection heater 19 in such a manner that it surrounds the circulation fan 17. And, the air intake ventilation holes 29 formed in the deep side wall surface 27 are arranged in front of the circulation fan 17, while the air feed ventilation holes 31 are arranged at positions along the rectangular-ring-shaped convection heater 19.

When the circulation fan 17 is driven and rotated, the wind generated flows from the front surface side of the circulation fan 17 to the rear surface side thereof where the drive motor 23 exists. As a result of this, the air existing in the interior of the heating chamber 11 is sucked through the air intake ventilation holes 29 into the central position of the convection heater 19 where the circulation fan 17 exists and is diffused radially there; and the air passes through the neighborhood of the convection heater 19 and is thereby heated, and is then charged through the air feed ventilation holes 31 into the heating chamber 11. Therefore, according to this flow of the air, the air existing within the heating chamber 11, while being stirred up, is allowed to circulate through the circulation fan chamber 25.

As shown in FIG. 2, the steam supply portion 15 comprises an evaporation dish 35 including a pool recessed portion 35a for generating steam S by heating, and an evaporation dish heating heater 37 disposed downwardly of the evaporation dish 35 for heating the evaporation dish 35. The evaporation dish 35 is composed of for example, a stainless-steel made plate member which includes a recessed portion and has a narrow and long shape. The evaporation dish 35 is disposed on the deep side bottom surface of the heating chamber 11 on the opposite side of the object-to-be-heated take-out mouth, while the longitudinal direction of the evaporation dish 35 extends along the deep side wall surface 27. By the way, as the evaporation dish heating heater 37, although not shown, there is employed a heater having a structure in which an aluminum die cast heat block with a heat generating element such as a sheath heater is in contact with the evaporation dish 35. Alternatively, the evaporation dish 35 may be heated with radiant heat using a glass tube heater or a sheath heater. Or, there may also be employed a structure in which a plate heater or the like is bonded to the evaporation dish 35.

Also, as shown in FIG. 1, within the main body case 10, there are disposed a water tank 53 for storing water therein which is to be supplied to the evaporation dish 35, a water pump 55, and a water supply pipe line 57 the discharge port of which is disposed opposed to the evaporation dish 35. Water, which is stored in the water tank 53, as the need arises, is supplied in a desired amount through the water supply pipe line 57 to the evaporation dish 35. By the way, in order that the cooking apparatus can be prevented from increasing in size when the water tank 53 is incorporated into the cooking apparatus, the water tank 53 is buried in a compact manner into the side wall portion of the main body case 10 that is relatively hard to become high in temperature. The water tank 53 is structured such that it can be pulled out from the side surface side of the main body case 10 to the outside; that is, the water tank 53 is removably mounted in the main body case 10. Alternatively, the water tank 53 may be adiabatically treated and may be disposed on the upper surface side of the cooking apparatus, or may be disposed on the lower surface side of the cooking apparatus.

The upper heating heater 16 is a plate heater such as a mica heater which applies heat for grill cooking or preheats the heating chamber 11; and, the upper heating heater 16 is disposed upwardly of the heating chamber 11. Also, the upper heating heater 16 may also be composed of a sheath heater instead of the plate heater. The thermistor 20 is disposed on the wall surface of the heating chamber 11 and is used to detect the temperature of the interior of the heating chamber 11. On the wall surface of the heating chamber 11, there is further provided the infrared sensor 18 in a freely oscillatable manner which can measure the temperatures of two or more portions (for example, 8 portions) at the same time. Using a scanning operation which oscillates the infrared sensor 18, the temperatures of two or more measuring points within the heating chamber 11 can be measured and further, to monitor the temperatures of the measuring points with the passage of time can tell the position of placement of the object to be heated M.

The tray 22, which acts as a vertically dividing partition plate, is removably supported on securing portions 26 which are respectively provided on the side surfaces 11a and 11b of the heating chamber 11. The securing portions 26 are arranged in two or more stages in such a manner that they can support the tray 22 at two or more height positions. By securing the tray 22 to the securing portions 26, the heating chamber 11 can be divided into an upper section space 11A and a lower section space 11B.

Now, FIG. 3 is a block diagram of a control system employed in the cooking apparatus 100 and this control system is mainly composed of a control part 501 including, for example, a microprocessor. The control part 501 mainly transmits and receives signals with respect to an input operation part 507, a display panel 509, the high frequency wave generating portion 12, the steam supply portion 15, the hot wind generating portion 14, the upper heating heater 16, a shutter opening and shutting drive portion 50 and the like; and, the control part 501 controls these respective portions. And, the temperature control part 501 functions as temperature control means (which will be discussed later) for controlling the atmospheric temperature of the interior of the heating chamber 11.

The input operation part 507 includes various kinds of keys such as a start switch, a switch for switching heating methods, and an automatic cooking switch; and, cooking is carried out by operating the keys properly according to the heating contents while confirming the temperatures displayed on the display panel 509.

To the high frequency wave generating portion 12, there are connected a motor (not shown) for driving the magnetron 13 and stirrer blade 33 and the like, and there is also connected a cooling fan 32 which is used to cool the magnetron 13. To the steam supply portion 15, there are connected the evaporation dish heating heater 37 and water pump 55; and, to the hot wind generating portion 14, there are connected the circulation fan 17 and convection heater 19. Also, to the shutter opening and shutting drive portion 50, there are connected an air intake side shutter 51 and an air exhaust side shutter 52.

Next, description will be given below of the basic operation of the cooking apparatus 100.

As shown in FIG. 2, firstly, a foodstuff, which is the object to be heated, is put on a dish or the like and is inserted into the heating chamber 11 and the opening and shutting door 21 is shut. By operating the input operation part 507, a cooking method, a heating time, a heating temperature and the like are set and, after then, when a start button is depressed, the cooking is carried out automatically according to the operation of the control part 501.

For example, when a mode “steam generation+circulation fan ON” is selected, since the evaporation dish heating heater 37 is switched on, water in the evaporation dish 35 is heated to thereby generate the steam S. The steam S rising from the evaporation dish 35 is sucked from the air intake ventilation hole 29 formed substantially in the central portion of the deep side wall surface 27 into the central portion of the circulation fan 17, is moved through the circulation fan chamber 25 and is blown out from the air feed ventilation hole 31 formed in the peripheral portion of the deep side wall surface 27 into the heating chamber 11. The thus blown-out steam is stirred up within the heating chamber 11 and is again sucked from the air intake ventilation hole 29 formed substantially in the central portion of the deep side wall surface 27 to the circulation fan chamber 25 side. This forms a circulation passage which extends over the interior of the heating chamber 11 and the interior of the circulation fan chamber 25. And, as shown by outlined arrow marks in FIG. 2, the steam S circulates through the heating chamber 11 and is thereby blown onto the object to be heated M.

In this case, since the steam S within the heating chamber 11 can be heated by turning on the convection heater 19, the temperature of the steam S circulating within the heating chamber 11 can be set at a higher temperature. Therefore, there can be obtained so called overheated steam, which makes it possible to cook the object to be heated while the surface thereof is browned. Also, to execute the high frequency wave heating, by turning on the magnetron 13 to thereby rotate the stirrer blade 33, the high frequency waves are supplied into the interior of the heating chamber 11 while they are stirred up uniformly, which makes it possible to execute uniform high frequency wave cooking.

As described above, according to the cooking apparatus 100, by using the magnetron 13, hot wind generating portion 14, steam supply portion 15 and upper heating heater 16 independently or in combination, the object to be heated (food) M can be heated according to the heating method that is best for cooking.

By the way, the temperature of the interior of the heating chamber 11 in the above-mentioned cooking time is measured by the infrared sensor 18 or thermistor 20 and, based on this measurement result, the control part 501 controls the magnetron 13, upper heating heater 16, convection heater 19 and the like properly. With use of the infrared sensor 18 capable of measuring the temperatures of two or more portions simultaneously, by oscillating the infrared sensor 18 to thereby scan the interior of the heating chamber 11, the temperatures of two or more measuring points within the heating chamber 11 can be measured in a short time and with high accuracy. By the way, when the interior of the heating chamber 11 is filled with the steam S, the infrared sensor 18, in some cases, is not be able to measure the temperature of the interior of the heating chamber 11 accurately; and, in this case, the measurement of the temperature of the interior of the heating chamber 11 may be made by the thermistor 20.

In addition to the above-mentioned basic operation, the cooking apparatus 100 according to the invention further has a function to control the atmospheric temperature of the interior of the heating chamber 11 to a temperature lower than the temperature of the steam to be supplied by driving and rotating the circulation fan 17.

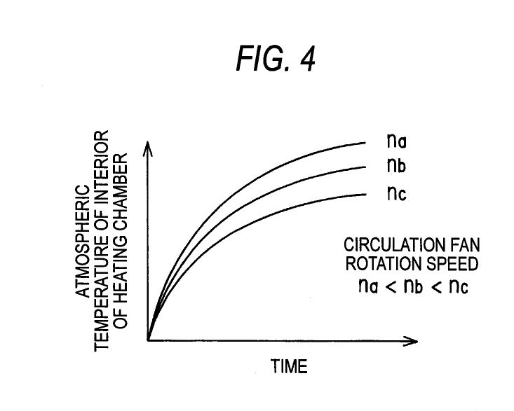

FIG. 4 shows variations with time in the atmospheric temperature of the interior of the heating chamber with respect to the respective rotation speeds of the circulation fan.

In other words, when the steam is continuously supplied from the steam supply portion 15 to the interior of the heating chamber 11 and also the circulation fan 17 is driven and rotated at the rotation speeds na, nb and nc (where na<nb<nc), the atmospheric temperature of the interior of the heating chamber 11 tends to decrease as the rotation speed of the circulation fan 17 increases. When the steam to be supplied to the heating chamber 11 is stirred up by the circulation fan 17 by making use of this characteristic, the atmospheric temperature of the interior of the heating chamber 11 can be lowered intentionally.

Specifically, because the steam S generated from the evaporation dish 35 is taken out by boiling water, the temperature of the steam S is about 100° C., whereas the temperature of a mixed gas generated by stirring up the steam S and the air existing in the interior of the heating chamber 11 is 100° C. or lower. Also, when the circulation fan 17 is rotated, a small amount of open air is introduced into the heating chamber 11 through clearances (clearances formed between the joints of metal plates and between the heating chamber 11 and opening and shutting door 21) formed in the wall surfaces and upper and lower surfaces that constitute the heating chamber 11 as well as through holes (such as the temperature detecting holes of the infrared sensor 18); and, the thus introduced open air is stirred up together with the steam S within the heating chamber 11, resulting in the lowered temperature of the mixed gas G. Therefore, by driving and rotating the circulation fan 17, the atmospheric temperature of the interior of the heating chamber 11 can be controlled to a desired temperature of 100° C. or lower that is best suited for the cooking.

For example, when heating the object to be heated at an atmospheric temperature near to 100° C. or lower, unless the heating time is set accurately, especially, in the case of egg cooking or the like the temperature of which is difficult to control, the cooking will fail. In this case, if the atmospheric temperature of the interior of the heating chamber 11 is previously set at a temperature (a temperature of less than 100° C.) suitable for the cooking, even when the cooking is continued longer than the prescribed time, the cooking can be prevented from failing.

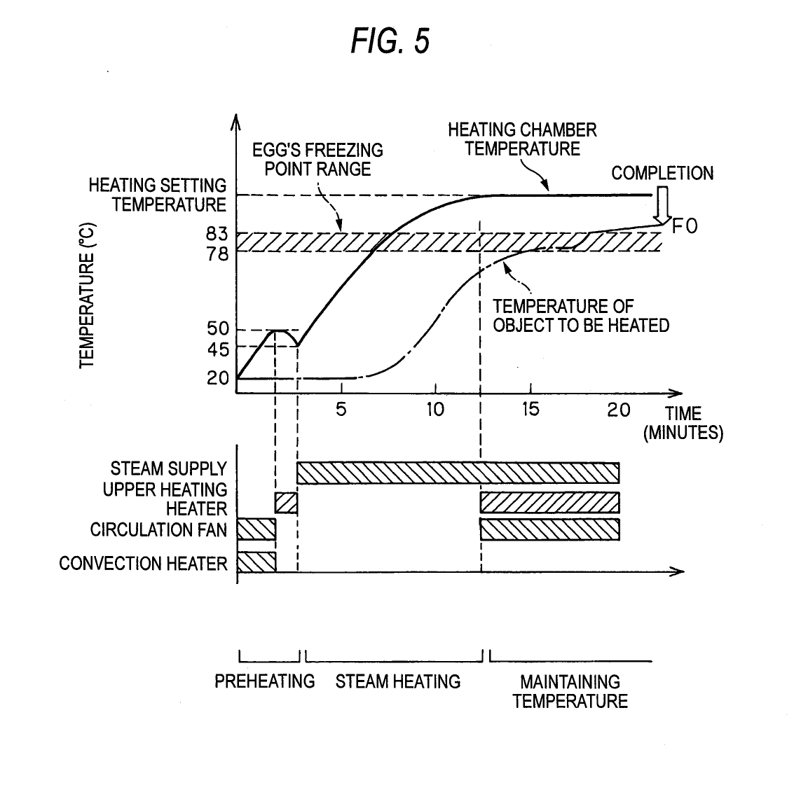

As an example of the cooking that is executed by controlling the atmospheric temperature of the interior of the heating chamber while using such circulation fan, description will be given below of a case in which a chawan mushi is cooked with reference to FIG. 5.

FIG. 5 shows the cooking pattern of a chawan mushi according to a method composed of “supply of steam+heating by heater”.

Firstly, a rice bowl, in which a foodstuff or the object to be heated M is stored, is put on the tray 22 (vertically dividing partition plate), the tray 22 is put into the heating chamber 11, and the opening and shutting door 21 is shut. The input operation part 507 is operated to set the heating method, heating time, heating temperature and the like, and the start button is depressed to start the cooking.

Based on an instruction from the control part 501, as a preheating step, the convection heater 19 is actuated to generate heat and the circulation fan 17 is rotated to thereby allow the hot wind to circulate within the heating chamber 11 for a given period of time (for example, one minute). By the way, when there is used the tray 22 including a microwave heat generating element, in stead of the hot wind circulation by the circulation fan 17 and convection heater 19, or in combination with this hot wind circulation, the magnetron 13 is used to preheat the object to be heated. Then, the upper heating heater 16 is operated to generate heat and the heat generating state of the upper heating heater 16 is maintained for a given period of time (for example, 30 seconds). Owing to this, the temperature of the interior of the heating chamber 11 is increased up to a preheating temperature of 45° C.-50° C. After then, the evaporation dish heating heater 37 is driven to generate heat to thereby heat and evaporate water in the pool recessed portion 35a of the evaporation dish 35, with the result that the steam S is generated. Thus, the temperature of the interior of the heating chamber 11 is gradually increased due to the steam S supplied to the heating chamber 11, while the temperature of the rice bowl or the object to be heated M is also increased gradually following the increasing temperature of the heating chamber 11. Here, for uniform temperature distribution by heating, within this temperature increasing period, the circulation fan may be rotated intermittently according to an increase in the temperature of the interior of the heating chamber 11.

Specifically, as shown in FIG. 2, firstly, when water is supplied from a water tank through a water pump to the evaporation dish 35 and the evaporation dish heating heater 37 is switched on, the water in the evaporation dish 35 is heated to thereby generate the steam S, and the steam S is diffused within the heating chamber 11.

The temperature of the interior of the heating chamber 11 soon reaches a previously set heating setting temperature. The then heating setting temperature is set lower than the temperature, 100° C., of the steam generated and, by stirring up the steam due to the rotation of the circulation fan 17, the temperature of the steam S generated is lowered down to a temperature of 100° C. or less.

In other words, the circulation fan 17 is driven and rotated by the drive motor 23, whereby there is generated a circulating air current within the heating chamber 11. The steam S filled into the heating chamber 11 is positively stirred up by an air current introduced from the air feed ventilation hole 31 of the deep side wall surface 27 and an air current sucked from the air intake ventilation hole 29 into the circulation fan chamber 25, whereby heat is exchanged between the steam S and air currents to lower the temperature of the steam S.

When the atmospheric temperature of the interior of the heating chamber 11 reaches the heating setting temperature, the amount of supply of the steam S is reduced and, instead, the upper heating heater 16 is driven to generate heat, which results in the excessive amount of steam. Such excessive amount of steam can prevent the door and the wall surface of the heating chamber from getting dewy. Also, by compensating the lowered amount of the steam supplied with heat generated from the upper heating heater 16, the interior of the heating chamber 11 can be maintained at a given set temperature. The power supply amount for the steam supply at the then time is set by distributing loads in such a manner that the total amount of such power supply amount and the amount of power supplied to the upper heating heater 16 does not exceed the range of the rated power, or by controlling the duty cycle of the upper heating heater 16. By the way, instead of the upper heating heater 16, the convection heater 19 may be used, or these two heaters may be used in combination.

In this manner, not only the heating by the upper heating heater 16 and the heating by the steam S are used in combination to continue the heating processing of the object to be heated, but also the circulation fan 17 is driven and rotated, whereby the temperature of the interior of the heating chamber 11 can be maintained at a given set temperature. In the case of the present cooking, since the freezing point temperature of an egg is substantially in the range of 78° C.-82° C., when the temperature of the chawan mushi 90 exceeds the freezing point temperature range, the cooking is ended. In this case, the time up to the end of the cooking of the chawan mushi 90 is about 20 minutes.

As described above, when a foodstuff is cooked using the steam heating, since the main heat transfer medium is the steam S, the amount of energy transmitted is large when compared with a cooking using the air as the heat transfer medium as in the oven heating. Therefore, the steam heating can heat the object to be heated M more quickly and, in addition, because the steam heating is excellent in heat exchange, the object to be heated M can be heated uniformly from the peripheral portions thereof to the interior portions thereof. Thanks to this, especially, in the cooking of the chawan mushi 90, the production of the separated portions of the egg and the unsatisfactory freezing of the egg due to the short heating can be prevented.

And, since the heating setting temperature is set at a temperature lower than the temperature, 100° C., of the steam generated, the atmospheric temperature of the interior of the heating chamber 11 takes longer time to pass through the egg freezing point temperature range, with the result that the heat can penetrate up to the interior of the object to be heated M to thereby be able to stably obtain a chawan mushi which is cooked satisfactorily. Also, even when the cooking time exceeds the preset time while heating the object to be heated M, the object to be heated M can be prevented from getting excessively high in the temperature and, therefore, the object to be heated M will not be influenced by this. This eliminates the possibility that the cooking can fail.

As a method for controlling or lowering the atmospheric temperature of the interior of the heating chamber by stirring up the steam in this manner, there can be employed not only a heating pattern for setting a single setting temperature but also a heating pattern for setting two or more setting temperatures sequentially.

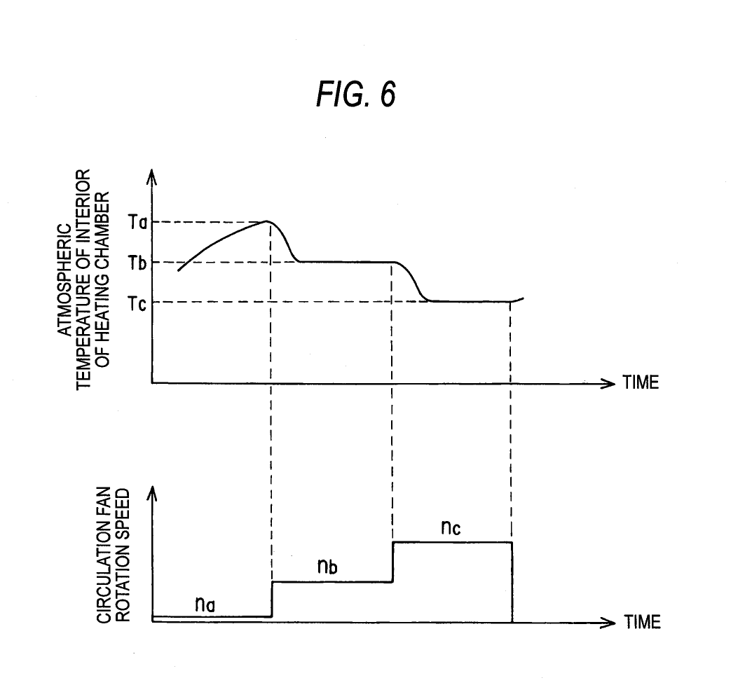

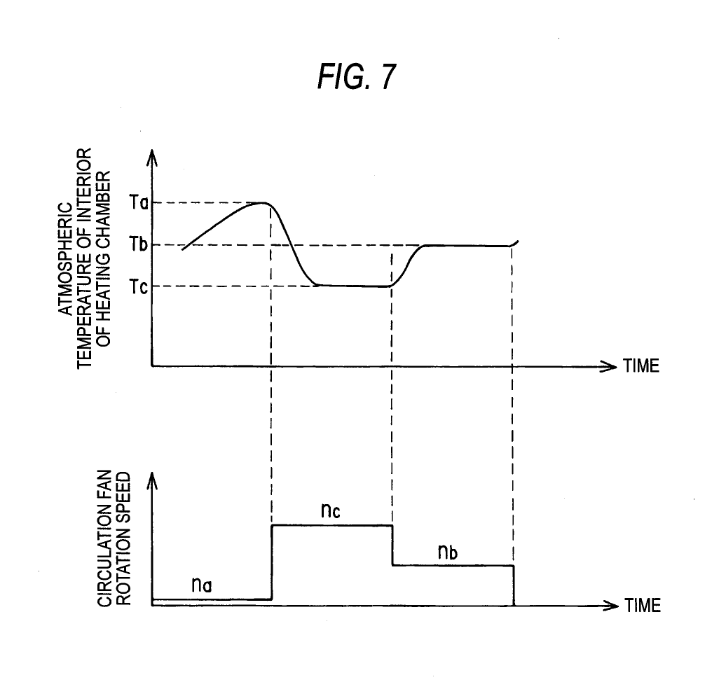

Now, FIGS. 6 and 7 are respectively charts to show embodiments in which the atmospheric temperatures of the interior of a heating chamber are set sequentially at different temperatures. Specifically, FIG. 6 shows an embodiment in which the atmospheric temperatures are set at temperatures sequentially decreasing with the passage of time, whereas FIG. 7 shows an embodiment in which the atmospheric temperatures are set at arbitrary temperatures free from the passage of time.

Firstly, as shown in FIG. 6, when the rotation speed of the circulation fan 17 is na, the atmospheric temperature of the interior of a heating chamber is increased by the steam supplied from the steam supply portion 15 up to a temperature Ta which is lower than a temperature when the circulation fan is not rotated. And, when the rotation speed of the circulation fan is increased up to nb, the atmospheric temperature of the interior of the heating chamber provides a temperature Tb which is lower than the temperature Ta. Further, when the rotation speed of the circulation fan is increased up to nc, the atmospheric temperature of the interior of the heating chamber is lowered down to a temperature Tc. In this manner, when the rotation speed of the circulation fan is increased sequentially, the atmospheric temperature of the interior of the heating chamber can be lowered gradually, which makes it possible to set a temperature which corresponds to the contents of the cooking.

Also, as shown in FIG. 7, when the rotation speed of the circulation fan 17 is controlled increasingly and decreasingly, specifically, when it is set firstly at na, secondly at nc and thirdly at nb, the atmospheric temperature of the interior of the heating chamber 11 can also be increased and decreased according to the rotation speeds of the circulation fan 17. In other words, by varying the rotation speeds of the circulation fan 17, the atmospheric temperature of the interior of the heating chamber 11 can be lowered down to an arbitrary temperature.

As has been described heretofore, with use of the cooking apparatus 100 according to the present embodiment, by controlling, that is, increasing or decreasing the rotation speed of the circulation fan 17, the atmospheric temperature of the interior of the heating chamber 11 can be changed freely and thus can be matched quickly and accurately to a desired heating chamber temperature equal to or lower than 100° C.

Now, description will be given below of a modification in which the atmospheric temperature of the interior of the heating chamber 11 is set at a desired heating temperature by controlling the rotation driving cycle of the circulation fan 17 instead of the rotation speed of the circulation fan 17.

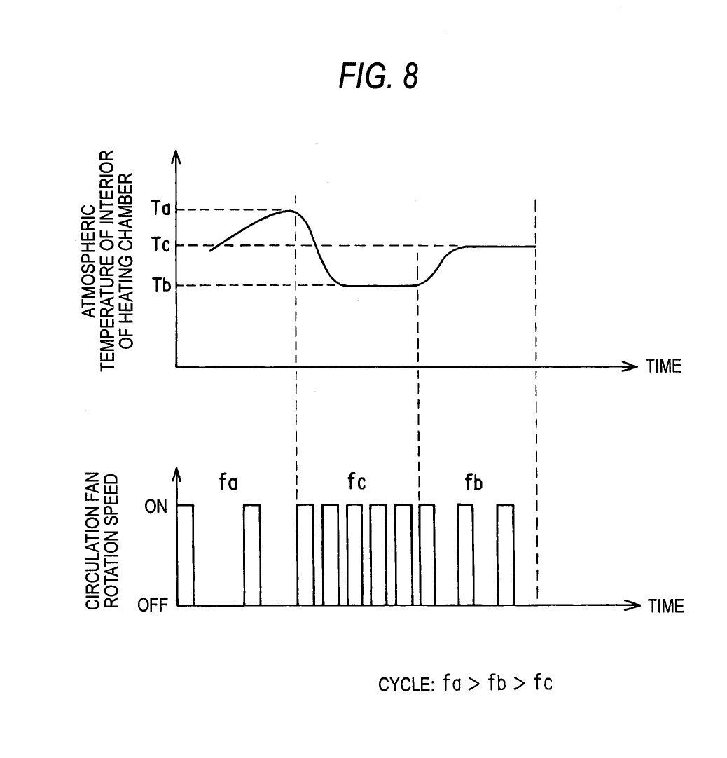

FIG. 8 is a chart to show an embodiment in which the atmospheric temperature of the interior of the heating chamber 11 is set at different temperatures by changing the rotation driving cycle of the circulation fan 17. Here, the term “the rotation driving cycle” means the time from the ON time to the next ON time when the ON/OFF of the rotation of the circulation fan is duty controlled.

When the rotation driving cycle of the circulation fan 17 is controlled, that is, the cycle is firstly increased up to fa, secondly decreased down to fc and thirdly increased up to fb (where, fa>fb>fc), the atmospheric temperature of the interior of the heating chamber 11 is also increased or decreased accordingly. In other words, by shortening the rotation driving cycle of the circulation fan 17, an effect of lowering the atmospheric temperature of the interior of the heating chamber 11 can be enhanced. According to this method as well, similarly to the previously described method, the atmospheric temperature of the interior of the heating chamber 11 can be changed freely and thus can be matched quickly and accurately to a desired heating chamber temperature equal to or lower than 100° C.

Next, description will be given below in detail of the effect provided by the tray 22 serving as the vertically dividing partition plate on which the object to be heated can be placed.

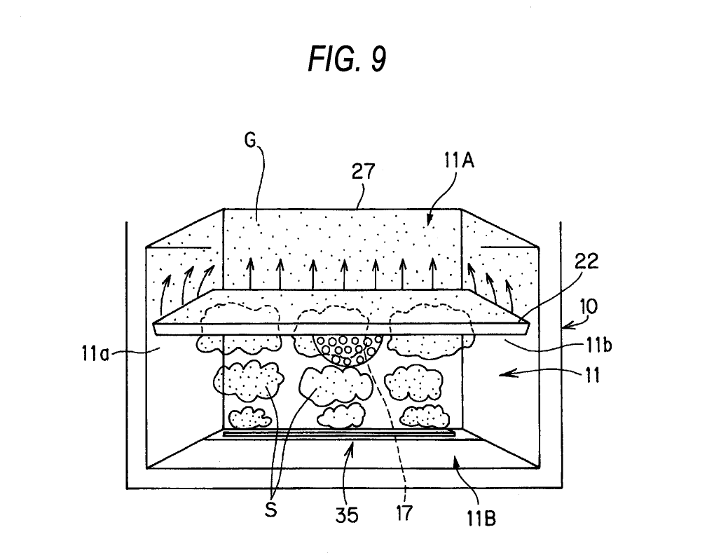

In the cooking apparatus 100 according to the present embodiment, when a space in the interior of the heating chamber 11 is vertically divided by the tray 22 into two section spaces, as the state of steam is shown in FIG. 9, the steam S generated from the evaporation dish 35 disposed in the lower section space 11B of the heating chamber 11 is stirred up sufficiently in the lower section space 11B by the circulation fan 17, thereby generating a mixed gas G the steam density of which is uniform. Here, the steam density means the occupied density of the steam with respect to the mixed gas which is composed of the steam generated from the evaporation dish 35 and the air. As the steam density increases, the existing amount of the steam per unit volume increases, with the result that the temperature of the mixed gas G becomes near to 100° C. On the other hand, as the steam density decreases, the existing amount of the steam per unit volume decreases, with the result that the temperature of the mixed gas G becomes low. The steam density can be controlled arbitrarily by adjusting the rotation speed of the circulation fan 17.

Since the mixed gas G with the steam S mixed therein has a lower specific gravity than the open air, the mixed gas G tends to move upward within the heating chamber 11. Because of this, the mixed gas G having a uniform steam density generated in the lower section space 11B of the heating chamber 11 moves through clearances between the inner wall surfaces (side wall surfaces 11a, 11b and deep side wall surface 27) and collects in the upper section space 11A. Thus, in the upper section space 11A existing upwardly of the tray 22, owing to the stirring operation, there gathers the mixed gas G having a given temperature lower than 100° C., so that substantially the whole of the interior of the upper section space 11A provides an atmosphere of a given constant temperature. In other words, the lower section space 11B functions as a steam S stirring space, whereas the upper section space 11A provides a cooking space which is maintained at a uniform temperature. Also, the mixed gas G the steam density of which has been made uniform in the lower section space 11B is supplied to the upper section space 11A uniformly along clearances between the tray 22 and the inner walls of the heating chamber, so that the temperature of the interior of the upper section space 11A provides a given uniform temperature everywhere.

In this manner, according to the cooking apparatus 100 of the present embodiment, not only the steam S is supplied into the heating chamber 11 but also the air is blown within the heating chamber 11 by the circulation fan 17, whereby the steam S supplied into the heating chamber 11 is positively stirred up to thereby be able to turn the interior of the heating chamber 11 into a desired atmospheric temperature. That is, there is generated the mixed gas G in which the steam S is sufficiently diffused into the air existing within the heating chamber 11, while this mixed gas G has a lower temperature than the steam S supplied. Therefore, the interior of the heating chamber 11 can be set at an arbitrary temperature suitable for cooking and thus cooking such as egg cooking requiring an accurate temperature setting can be carried out quickly and positively.

Also, since there is disposed the tray 22 for dividing the heating chamber 11 into upper and lower section spaces and the steam S is supplied to the lower section space 11B existing downwardly of the tray 22, the steam S supplied rises from the lower section space 11B, moves through the communicating portions between the tray 22 and the wall surfaces of the heating chamber 11, and collects into the upper section space 11A. The path of the steam S through these narrow passages can further facilitate the stirring of the steam S, so that the steam density in the upper section space 11A of the heating chamber 11 can be made uniform.

And, in the present cooking apparatus 100, because the steam S is supplied into the heating chamber 11 from the evaporation dish 35 disposed within the heating chamber 11, not only the structure of the cooking apparatus 100 can be simplified when compared with a cooking apparatus in which a boiler device is provided outside the heating chamber 11, but also dirt such as a scale attached to the evaporation dish 35 can be removed simply to thereby be able to maintain a sanitary environment easily.

Here, the above-mentioned tray 22 may also be structured in the following manner.

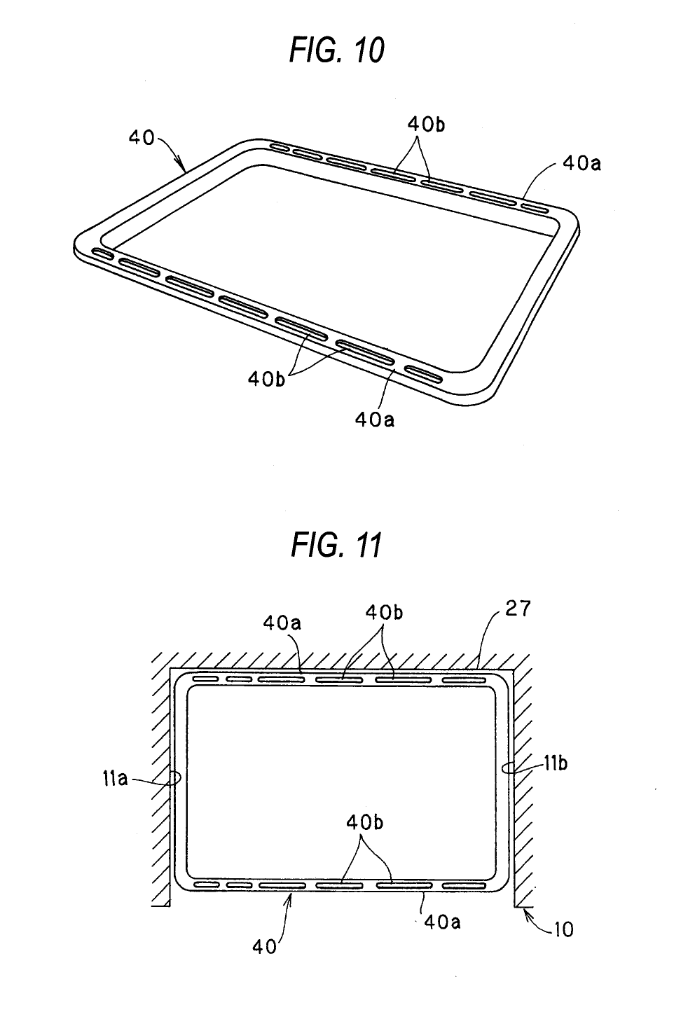

FIG. 10 is a perspective view of a modification of the tray 22, and FIG. 11 is a transverse section view of the tray shown in FIG. 10, showing a state in which it is stored in a heating chamber.

As shown in FIGS. 10 and 11, the tray 40 includes two or more open holes 40b formed in the edge portions 40a of the tray 40 so as to penetrate through the edge portions 40a vertically, while the edge portions 40a respectively provide the far (deep) and near (this) sides of the tray 40 when the tray 40 is stored in the heating chamber 11. The open holes 40b may be disposed at such positions as are opposed to the steam supply portion 15 and they must not be always formed in both of the far and near sides of the tray 40. However, when the open holes 40b are formed in both of the far and near sides, the tray 40 can be mounted into the heating chamber 11 without paying attention to the direction of the tray 40, which can enhance the handling efficiency of the tray 40.

Thanks to this, the mixed gas G, which is generated in the lower section space 11B of the heating chamber 11 due to the mixed and stirred steam and open air, can be positively supplied to the upper section space 11A through the open holes 40b of the tray 40. Therefore, without applying the mixed gas G strongly to the local portions of the object to be heated M put on the tray 40, the object to be heated M can be heated in an atmosphere in which the whole of the object to be heated M is wrapped in the steam S. Also, owing to the open holes 40b of the tray 40, the flow of the rising steam S provides a flow penetrating through the upper and lower section spaces, thereby eliminating a possibility that the steam S can stay in the upper section space 11A. Further, aside from the formation of the open holes 40b in the tray 40, there may also be formed recessed portions in the wall surfaces of the heating chamber 11 and the steam S may flow from the recessed portions in such a manner that it penetrates through the upper and lower section spaces.

Next, description will be given below of a second embodiment of a cooking apparatus according to the invention.

A cooking apparatus 200 according to the present embodiment, in addition to the structure of the cooking apparatus 100 according to the previously described first embodiment, further includes an air intake and exhaust mechanism which not only takes in the open air positively but also exhausts the air existing within the heating chamber positively.

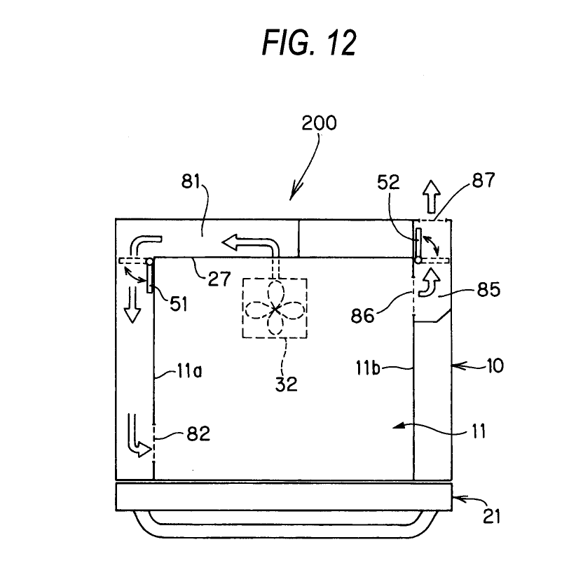

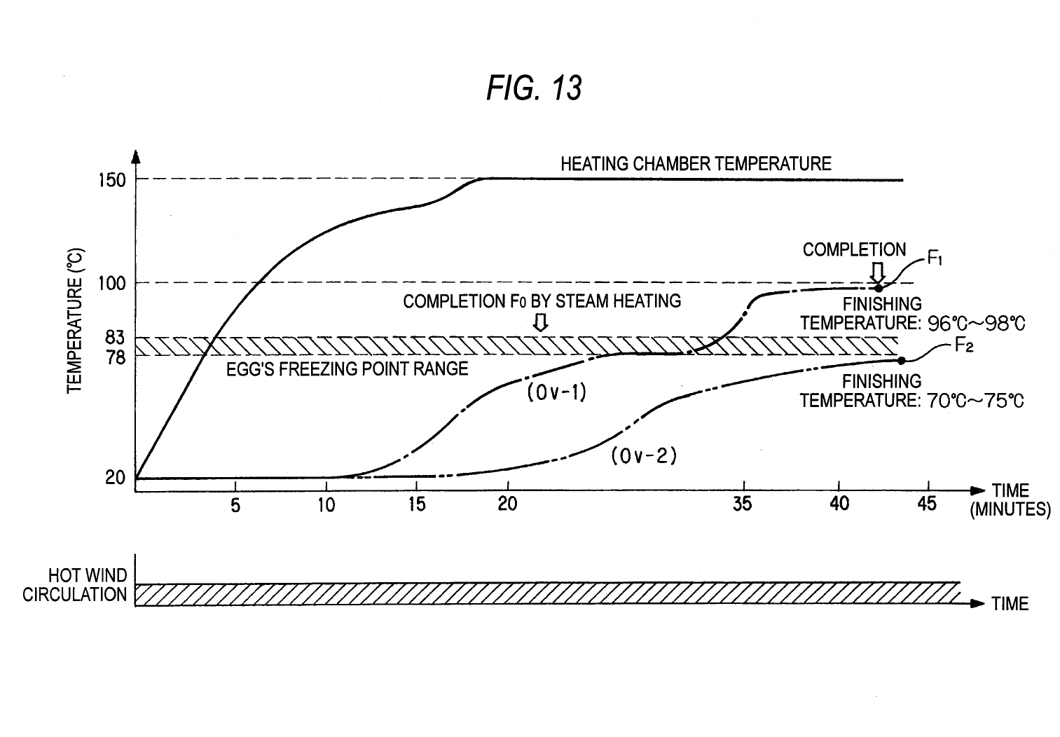

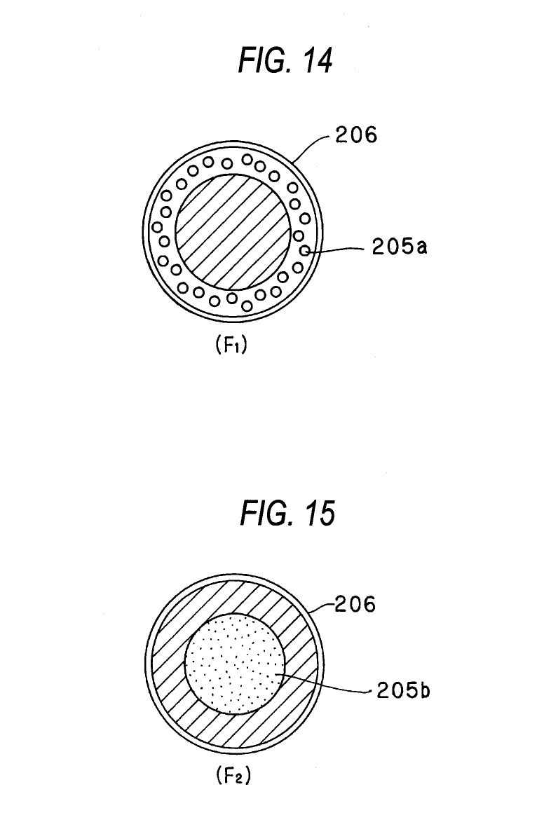

Now, FIG. 12 is a plan view of a cooking apparatus according to a second embodiment of the invention, showing the schematic structure of the air intake and exhaust mechanism of the present cooking apparatus. As shown in FIG. 12, the cooking apparatus 200 according to the present embodiment includes an air intake ventilation passage 81 for introducing the open air into the heating chamber 11, an air exhaust ventilation passage 85 for exhausting the air existing within the heating chamber 11, an air intake side shutter 51, an air exhaust side shutter 52, and a shutter opening and shutting drive portion 50 (see FIG. 3). In other words, the present cooking apparatus 200 is structured such that it includes exhaust means for exhausting steam supplied to the heating chamber 11 from the heating chamber 11.

In the cooking apparatus 200 according to the present embodiment, an air intake port 82, which is to be connected to the air intake ventilation passage 81, is formed in such lower portion of the left side wall surface 11a of the heating chamber 11 that exists near to the opening and shutting door 21 shown in FIG. 1, while the air intake port 82 is open to the lower section space 11B of the heating chamber 11. Also, an air exhaust port 86 is formed in such portion of the right side wall surface 11b of the heating chamber 11 that is the deep side lower end of the heating chamber 11 shown in FIG. 1, while the air exhaust port 86 is open to the lower section space 11B of the heating chamber 11.

The air intake port 82 is in communication with the air intake ventilation passage 81 which is secured not only between the outside surface of the main body case 10 and the side wall surface 11a of the heating chamber 11 but also between the outside surface of the main body case 10 and the deep side wall surface 27; and, in the intermediate portion of the air intake ventilation passage 81, there is disposed the air intake side shutter 51 which can be opened and shut freely. And, by switching the air intake side shutter 51, the wind from the cooling fan 32 provided integrally with the magnetron 13 for cooling the magnetron 13 can be blown from the air intake port 82 through the air intake ventilation passage 81 into the heating chamber 11.

By the way, the cooling fan 32 is not limited to a fan for cooling a magnetron but, as shown in a block diagram of FIG. 3, there may be provided a ventilation fan 60 separately and this ventilation fan 60 may be used to blow the wind. When the open air is supplied directly to heating chamber 11 using the ventilation fan 60, there may be a fear that the temperature of the interior of the heating chamber 11 can be cooled suddenly. In this case, a heater may be mounted on the ventilation fan 60, or the warmed air obtained by cooling the magnetron 13 using the magnetron cooling fan 13 may be supplied to the heating chamber 11.

The air exhaust port 86 is in communication with the air exhaust ventilation passage 85 secured between the outside surface of the main body case 10 and the side wall surface 11b of the heating chamber 11 and, in the intermediate portion of the air exhaust ventilation passage 85, there is provided the air exhaust side shutter 52 which can be opened and shut freely.

The air exhaust ventilation passage 85 is in communication with the outside through a discharge port 87. And, by opening the air exhaust side shutter 52, as the air is supplied into the heating chamber 11, the air existing within the heating chamber 11 can be exhausted to the outside.

The air intake side shutter 51 and air exhaust side shutter 52 are respectively composed of, for example, a damper normally energized in one direction by a spring or the like; and, by oscillating the dampers of the air intake side shutter 51 and air exhaust side shutter 52 using an electromagnetic force, the air intake ventilation passage 81 and air exhaust ventilation passage 85 can be held selectively in the opened or cut-off state thereof. Or, the dampers may be structured such that they can be switched from their shut states to their opened states due to the wind pressure. In this case, the shutter mechanism can be simplified further. The air intake side shutter 51 and air exhaust side shutter 52 are normally shut unless the air intake and exhaust is necessary, in order to prevent the steam in the interior of the heating chamber 11 from leaking out to the outside unexpectedly.

The open air sucked from the outside by the cooling fan 32 is blown through the air intake ventilation passage 81 and air intake side shutter 51 into the heating chamber 11 from the air intake port 82. Owing to the air supply from the air intake port 82, the air existing within the heating chamber 11 is exhausted from the air exhaust port 86 through the air exhaust ventilation passage 85, air exhaust side shutter 52 and discharge port 78 to the outside. At the then time, the air existing within the heating chamber 11 flows substantially diagonally, so that the air can be stirred up and ventilated with high efficiency.

According to the present cooking apparatus 200, while the steam is supplied into the heating chamber 11, not only the wind from the ventilation means is introduced through the air intake ventilation passage 81 into the heating chamber 11 but also the air existing within the heating chamber 11 is exhausted from the air exhaust ventilation passage 85, so that the steam supplied into the heating chamber 11 can be stirred up positively by the open air to thereby be able to turn the interior of the heating chamber 11 into a desired steam density. In other words, the steam is sufficiently diffused into the air existing within the heating chamber 11 to thereby generate the mixed gas G, while the temperature of the mixed gas G becomes lower than the temperature of the steam supplied. Therefore, in the cooking apparatus 200 according to the present embodiment as well, to set the heating chamber 11 at an arbitrary temperature of 100° C. or lower suitable for cooking can be executed with higher efficiency, so that cooking such as egg cooking requiring an accurate temperature setting can be carried out quickly and positively.

Here, the air intake side shutter 51 and air exhaust side shutter 52 are not limited to those which are to be held in the opened state or in the shut state, but there may also be used other shutters which can arbitrarily set the opening degrees of the air intake ventilation passage 81 and air exhaust ventilation passage 85. In this case, fine temperature control can be realized, thereby being able to enhance the freedom of the cooking.

Although the present invention has been described heretofore in detail and with reference to the specific embodiments thereof, it is obvious to those skilled in the art that there are possible various changes and modifications without departing from the spirit and scope of the invention.

The present application is based on the Japanese patent application No. 2004-126434 filed on Apr. 22, 2004 and the contents thereof are incorporated into the present application as reference.

### INDUSTRIAL APPLICABILITY

According to a cooking apparatus and a cooking method of the invention, by stirring up the steam supplied into the heating chamber, the atmospheric temperature of the interior of the heating chamber can be set lower than the temperature of the steam supplied, and thus the atmospheric temperature of the interior of the heating chamber can be lowered quickly and positively down to a temperature suitable for cooking an object to be heated.

1. A cooking apparatus which supplies steam to a heating chamber storing therein an object to be heated to heat the object, comprising:
steam supply means for supplying the steam to the heating chamber;
a fan for stirring up the steam supplied into the heating chamber; and,
temperature control means, by driving and rotating the fan, for controlling the atmospheric temperature of the interior of the heating chamber to be lower than the temperature of the steam supplied.

2. A cooking apparatus as set forth in claim 1, further including heating means for raising the temperature of the atmospheric temperature of the interior of the heating chamber.

3. A cooking apparatus as set forth in claim 1, wherein the heating chamber is separated through a partition plate from a circulation fan chamber in which the fan is disposed and, in the partition plate, there are formed ventilation holes allowing the heating chamber and the circulation fan chamber to communicate with each other.

4. A cooking apparatus as set forth in claim 1, wherein open air supply means for supplying the open air is connected to the heating chamber.

5. A cooking apparatus as set forth in claim 4, wherein the open air supply means includes: ventilation means for sucking the open air to generate the wind; an air intake ventilation passage for guiding the wind from the ventilation means to the heating chamber; and, an air exhaust ventilation passage for exhausting the air existing within the heating chamber.

6. A cooking apparatus as set forth in claim 5, wherein, in a portion of the air intake ventilation passage upstream of its connecting position with the heating chamber, there is disposed an air intake side shutter for limiting the flow rate of the air passing through the air intake ventilation passage.

7. A cooking apparatus as set forth in claim 5, wherein, in a portion of the air exhaust ventilation passage upstream of its connecting position with the heating chamber, there is disposed an air exhaust side shutter for limiting the flow rate of the air passing through the air exhaust ventilation passage.

8. A cooking apparatus as set forth in claim 1, further including a vertically dividing partition plate for vertically dividing a space in the interior of the heating chamber into upper and lower section spaces, wherein a communication portion is interposed between the heating chamber and the vertically dividing partition plate for connecting together the upper and lower section spaces, and the steam supply means supplies steam from the lower section space of the heating chamber.

9. A cooking method for supplying steam to a heating chamber storing an object to be heated therein to heat the object to be heated, wherein not only the object to be heated is heated while supplying the steam to the heating chamber but also the steam supplied to the interior of the heating chamber is stirred up to thereby control the atmospheric temperature of the interior of the heating chamber to be lower than the temperature of the steam supplied.

10. A cooking method as set forth in claim 9, wherein the stirring-up of the steam is executed by driving and rotating a fan, and the atmospheric temperature of the interior of the heating chamber can be changed by controlling, that is, increasing or decreasing the rotation speed of the fan.

11. A cooking method as set forth in claim 9, wherein the stirring-up of the steam is executed by driving and rotating the fan, and the atmospheric temperature of the interior of the heating chamber can be changed by controlling the rotation driving cycle of the fan.
